(19) United States
(12) Patent Application Publication
(10) Pub. No.: US 2003/0197936 A1
(43) Pub. Date: Oct. 23, 2003

(54) Tunable polarization mode dispersion compensation using multi-layered reflector

(75) Inventors: Zhang Wang, Stanford, CA (US); David A.B. Miller, Stanford, CA (US); Shanhui Fan, Palo Alto, CA (US)

Correspondence Address: PARSONS HSUE & DE RUNTZ LLP, 655 MONTGOMERY STREET, SUITE 1800, SAN FRANCISCO, CA, 94111, US

(73) Assignee: THE BOARD OF TRUSTEES OF THE LELAND STANFORD JUNIOR UNIVERSITY

(21) Appl. No.: 10/126,859

(22) Filed: Apr. 18, 2002

(51) Int. Cl. G02B 5/30; G02B 27/28; G02B 5/28

(52) U.S. Cl. 359/487; 359/502; 359/589

(57) ABSTRACT

We describe a novel approach for tunable polarization mode dispersion (PMD) compensation using multi-layered thin-film dielectric reflectors. This design can compensate for both the first-order PMD and the second-order PMD in ultrahigh speed optical fiber communication systems. Built-in cavity layers constitute optical resonators localizing electromagnetic energy at a specific frequency in the cavity region and therefore generating dispersive reflection. The two principal states of polarization in this system, TE and TM modes, demonstrate different dispersion responses for oblique incidences, which can be readily tuned to offset the PMD accumulated in fiber links. Various schemes of dispersion generation could be designed using single-cavity cascading or with coupled multiple-cavity resonator structures. In particular, these cavity resonators can be designed in a specific way to create high dispersion contrast between the two polarizations over a broad bandwidth, while maintaining very low loss, thanks to its complete reflective nature. Furthermore, this technique also benefit from its fast and flexible angular tuning to accomplish the adaptiveness in PMD compensation.

### BACKGROUND OF THE INVENTION

This invention relates in general to a polarization mode dispersion compensation, and, in particular, to the use of a multi-layer reflector device having at least one cavity therein to compensate for the polarization mode dispersion.

Polarization mode dispersion (PMD) is an imminent bandwidth-limiting issue for speed upgrade in ultrahigh speed communication system using installed optical fiber links and for long-distance high-speed fiber links in general. Under zero stress, fibers with perfectly circular core and cladding and with angularly uniform material composition are free of PMD. However, in practice, cabled fibers do show polarization mode dispersion to some extent due to manufacturing imperfections, time-variant stresses and ambient temperature changes. The first-order PMD results from the differential group delay between the two principal states of polarizations in the fibers. Pulse broadening thus occurs as the two polarizations travel at different speeds from the transmitter to the receiver. Because the tolerance of such broadening is inversely proportional to the data rate, this broadening must be compensated for in fiber link with data rate greater than 40 Gbps. Such delay must be compensated to restore the original signal for communication systems operating at high data rates (40 Gbit/s and above) and over long reaches (1000˜3200 km).

In addition, for higher speed communication systems beyond 100 Gbps, the differential group velocity dispersion between polarizations, i.e. second-order PMD, results in significant extra signal distortion if not corrected. The typical PMD for the non-return to zero (NRZ) signal on standard single mode fibers (SMF) is approximately 0.1 ps/\sqrt{km}. corresponding to a significant differential group delay up to 36 ps over a propagation distance of 3600 km. See, for example, Iannone, E. et al. “Nonlinear Optical Communication Networks”, (John Wiley & Sons, 1998). Moreover, the time-variant nature of PMD makes adaptive compensation indispensable.

In order to compensate for PMD in fiber communication systems, a polarization-dependent dispersive device is therefore critically needed. Previously, most of the PMD compensation devices use polarization beam splitters (PBS) to split the PMD-distorted signal into two principal states of polarization (PSP). Polarization maintaining fibers are then employed and tuned as delay lines to synchronize the fast PSP component with the slow one. These two components are recombined to reproduce the original signal in a second PBS. Separate polarization-dependent splitters and delay lines have to be used in this type of design. Prior techniques are explained in more detail in the following articles:

(1) Rosenfeldt, H.; Ulrich, R.; Feiste, U.; Ludwig, R.; Weber, H. G.; Ehrhardt, A., “PMD compensation in 10 Gbit/s NRZ field experiment using polarimetric error signal”, Electronics Letters; 2000; v.36, no. 5, p. 448-450;

(2) Pua, Hok Yong; Peddanarappagari, Kumar; Zhu, Benyuan; Allen, Christopher; Demarest, Kenneth; Hui, Rongqing, “Adaptive first-order polarization-mode dispersion compensation system aided by polarization scrambling: theory and demonstration”, Journal of Lightwave Technology; 2000; v.18, no.6, p.832-841;

(3) Sobiski, D.; Pikula, D.; Smith, J.; Henning, C.; Chowdhury, D.; Murphy, E.; Kolltveit, E.; Annunziata, F., “Fast first-order PMD compensation with low insertion loss for 10 Gbit/s system”, Electronics Letters; January 2001; v.37, no.1, p.46-48; and

(4) Madsen, C. K., “Optical all-pass filters for polarization mode dispersion compensation”, Optics Letters; Jun. 15, 2000; vol.25, no.12, p.878-80.

### SUMMARY OF THE INVENTION

A multi-layer reflector device having at least one cavity therein is used to compensate for polarization mode dispersion. Associated with the device are different phase response functions with respect to two orthogonal polarization directions. The device is interacted with a beam of electromagnetic radiation having two orthogonal polarized components with polarization mode dispersion between them in such a manner that a differential phase response between the components is reduced. In one embodiment, the two orthogonal polarized components have a differential group delay and/or a differential group velocity dispersion between the components. The beam is interacted with the device in such manner that the device reduces the differential group delay and/or differential group velocity dispersion between the components. Other than the differential group delay and differential group velocity dispersion, other differential phase response between the components may also be reduced in the interaction with the device.

### BRIEF DESCRITION OF THE DRAWINGS

FIG. 1a is a perspective view of a multi-layer dielectric thin-film reflector with one resonant cavity useful for illustrating the invention.

FIG. 1b is a perspective view of a multi-layer dielectric thin-film reflector with embedded cavities useful for illustrating the invention.

FIG. 1c is a schematic view showing in perspective cascaded multi-layer film resonators to illustrate one embodiment of the invention.

FIG. 2a is a graphical illustration of a reflectance spectrum for TE mode at three different incidence angles 0°, 45° and 80° to the normal direction to the surface useful for illustrating the invention, where TE mode is defined as the mode that has its electric field parallel to the mirror surface.

FIG. 2b is a graphical illustration of a reflectance spectrum for TM mode at three different incidence angles 0°, 45° and 80° to the normal direction to the surface, where TM mode has its magnetic field parallel to the mirror surface. It is noted from these figures that the frequency range between dashed lines corresponds to omni-reflectance extending from 1250 to 1700 nanometers. a resonance wavelength at 1550 nanometers and a bandwidth of 34 GHz.

FIG. 3a is a graphical illustration of the phase shift of reflection functions of the TE and TM modes useful for illustrating the invention.

FIG. 3b is a graphical illustration of the group delays of the TE and TM modes useful for illustrating the invention. The cavity is designed to have a resonance wavelength at 1550 nanometers with 34 GHz bandwidth

FIG. 3c is a graphical illustration of the dispersions for TE and TM modes of a single cavity reflector designed to have a resonance wavelength at 1550 nanometers.

FIG. 4 is a graphical illustration of the group delay spectra of the TE and TM modes of a single-cavity reflector at various incidence angles (0°, 27°, 54° and 72° to the normal direction to the surface of the reflector).

FIG. 5a is a schematic view of a tapered reflector and a radiation beam incident on the reflector at three different incidence angles and at three different locations useful for illustrating an embodiment of the invention.

FIG. 5b is a graphical illustration of the differential group delay spectra of the reflector of FIG. 5a. Reflections with incidence angles of 30°, 45° and 60° generate spectra with quality factor Q equal to 1000, 1800 and 3400, respectively. The resonant frequencies of are fixed at 1550 nanometers by moving the reflector along the tapered direction as shown in FIG. 5a.

FIGS. 5c, 5d and 5e are schematic side views illustrating the three different incidence angles of the beam at the three different locations in FIG. 5a.

FIG. 5f is a schematic front view of a reflection on a tapered reflector with an incident angle of 30°, same as in FIG. 5e.

FIG. 6a is a schematic view of a multi-stage reflector illustrating another embodiment of the invention.

FIG. 6b is a graphical illustration of the delay spectrum of the device of FIG. 6a, where the solid line corresponds to the delay spectrum of the entire device and dotted lines are those of single reflections in each stage.

FIG. 6c is a graphical illustration of the delay spectrum of the structure in FIG. 6a, in the variation of the overall delay when the incidence angle is varied. The incident angle is adjusted to vary the spacing between the peaks at either side of the signal band.

FIG. 7a is a perspective view of a system of two reflectors that generate second-order PMD. The two arrows represent the two principal states of polarization in the incoming signal. The polarization state represented by the outlined or hollow arrows as a TE mode with respect to the first mirror, and a TM mode with respect to the second mirror. The opposite holds true for the polarization state depicted by the solid or entirely dark arrow.

FIG. 7b is a graphical illustration of the differential velocity dispersion response of the structure of FIG. 7a. Before and after the reflections at the two main stages, additional reflectors may be employed that support 11 reflections respectively. Additionally, a supplemental third stage is employed to flatten a portion of the dispersion at high dispersion cases similar to the effect shown in FIG. 6b.

FIG. 8 is a graphical illustration of the changes in the shape of the beam that proceeds through the structure in FIG. 5a after 28 reflections.

FIG. 9 is a graphical illustration of the overall group delay for TE modes in a reflector with two coupled cavities such as the one in FIG. 1b. The flat top of delayed spectra 50 +or −0.6 ps delay over a 12 GHz bandwidth.

FIG. 10a is a graphical illustration of the reflectance spectra of TM mode at various angles of incidence on a dielectric stack reflector with small refractive index contrast of 2.2/1.7. No frequency range with 100% reflection at all angles is observed.

FIG. 10b is a graphical illustration of the differential group delay spectra of the reflector of FIG. 10a. The line shape of the delayed peaks from the cavity for the two polarizations are similar to that in FIG. 3b. The split between these peaks and quality factors becomes smaller when refractive index contrast is reduced. Operational incidence angle and number of bilayers on the incidence side of the cavity are large.

For simplicity in description, identical components are labeled by the same numerals in this application.

### DETAILED DESCRIPTION OF THE PREFERRED EMBODIMENTS

In this disclosure, we present a novel design for polarization mode dispersion compensation scheme. This design uses a cavity embedded in a multilayer reflector. For our purpose here, we use a reflector preferably possessing near 100% reflectivity within a range of off-normal angles, for both polarizations in the vicinity of the signal frequency, and generating tunable differential delay or dispersion between the two polarizations. Particularly, one preferred embodiment is an omnidirectional reflector, a periodic multilayer dielectric stack with appropriate refractive indices and thicknesses. As an example, please see Fink, Y.; Winn, J. N.; Shanhui Fan; Chiping Chen; Michel, J.; Joannopoulos, J. D.; Thomas, E. L., “A dielectric omnidirectional reflector”, Science; Nov. 27, 1998; vol. 282, no. 5394, p. 1679-82.

Such a reflector possesses near 100% reflectivity within a range of frequencies, regardless of incidence angles and polarizations. The cavity is configured in an “all-pass filter” geometry: the reflector on one side of the cavity, from which side the light is incident upon, possesses far larger transmissivity than the reflector on the other side. In such geometry, the reflectance remains approximately 100% over all values of incidence angles within a frequency range and the cavity mode exhibits its effects only in the phase response function around the resonance frequency. Previously, multi-layer allpass filters have been used for group velocity dispersion compensation. Examples of such filters can be found in Jablonski, M. et al. “Entirely Thin-Film Allpass Coupled-cavity Filters in a Parallel Configuration for Adjustable Dispersion-Slope Compensation”, IEEE Photonics Tech. Let.; November 2001; vol. 13, no.11, pp. 1188-1190.

Here, with the use of the omni-directional reflector we extend the “all-pass” characteristics of the multiplayer structure to all incidence angles. This omni-directional property, in combination with the polarization and angular dependency of the cavity modes, thus provides important opportunities for engineering desirable polarization mode dispersion properties. In this disclosure, we show that this property can be exploited to design an element that further exhibits tunable polarization mode dispersion. While the preferred embodiment employs an omni-directional reflector, other multilayered reflectors with high reflectance at off-normal incidence angles may also be used.

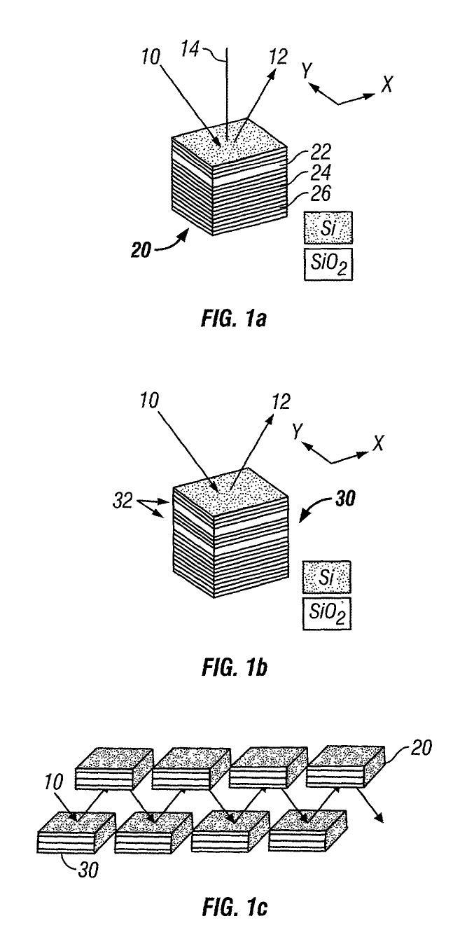

In FIG. 1, we show several basic designs of structures that can be used for PMD compensation. FIG. 1(a) shows the basic structure 20 with single resonant cavity 22 embedded in a multi-layer stack. A beam of radiation 10 is reflected by structure 20. Depending on the angle of incidence of beam 10 to a direction 14 normal to the surface of reflector 20 and passing through the beam, the PMD between two orthogonal polarized components present in beam 10 can be reduced by the reflection in reflected beam 12. The structure comprises alternating high and low refractive index layers, such as Si layer 24 and SiO₂ layer 26, respectively here in the figure, for concreteness. The cavity is created, for example, by removing a layer of silicon. This optical resonator will generate a Lorentzian group delay peak within the complete reflection frequency range. Coupling the basic cavity structures together can generate more complex spectra to compensate for the time-variant PMD in fiber links. Coherent coupling shown in FIG. 1(b) offers larger delay in single reflection by embedding multiple cavities 32 in one reflector 30. On the other hand, incoherent cascading shown in FIG. 1(c) allows flexible tailor on the group delay spectra and larger delay or dispersion through multiple reflections. Each of the devices 20 and 30 has different phase response functions with respect to two orthogonal polarization directions, such as X and Y.

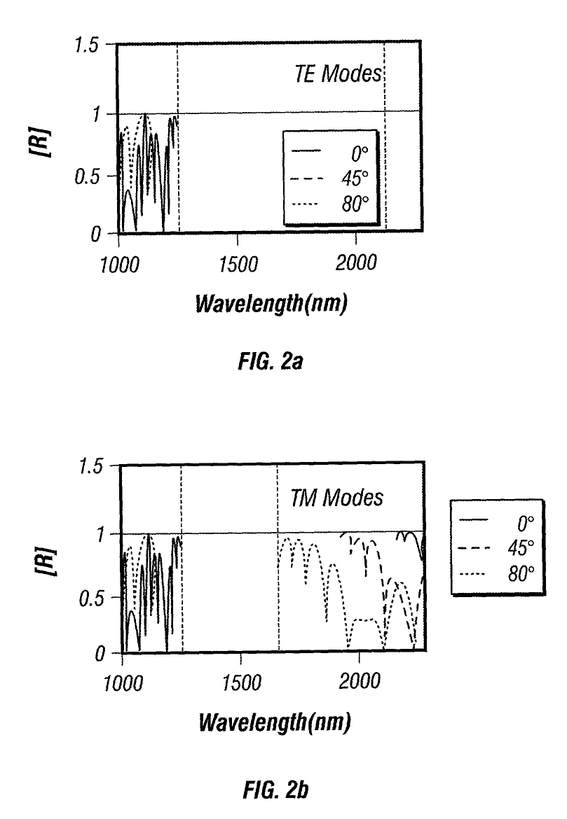

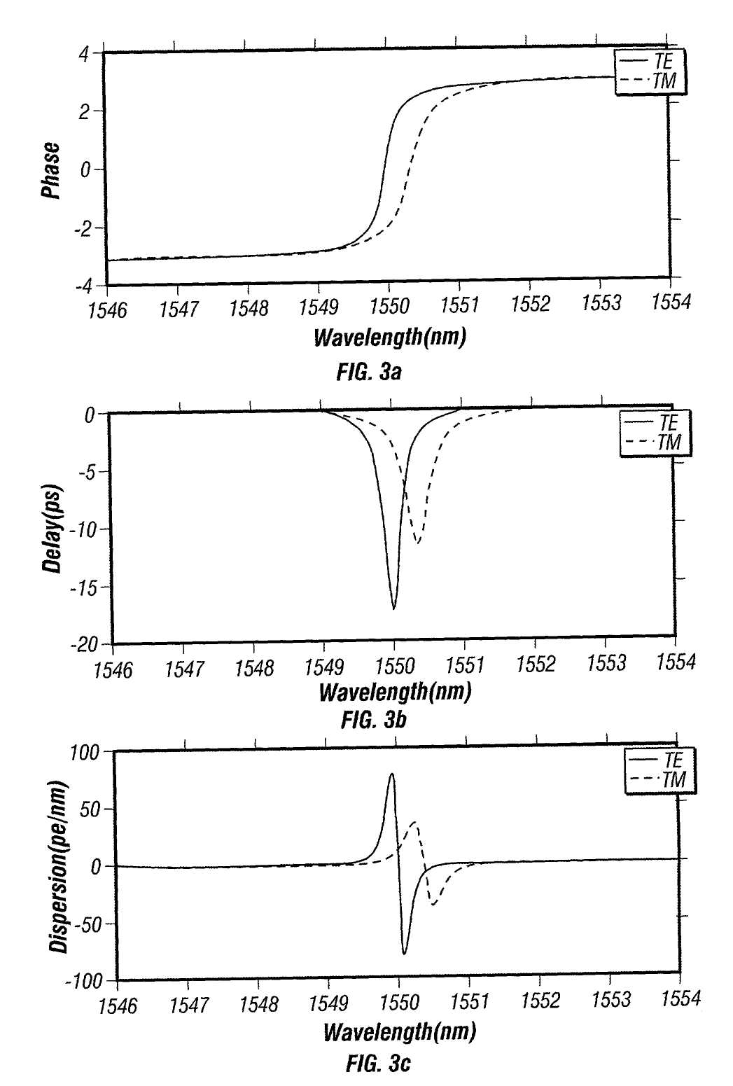

The phase response of the reflection function characterizes the basic optical property of these embedded cavities, as the amplitude of the reflection is unitary in the entire frequency range of the total reflection. For a single cavity embedded in a Si/SiO₂ structure, the reflectivity is indeed 100% within the wavelength range between 1250 and 1700 nm for both polarizations and for all incidence angles (FIG. 2). As shown in FIG. 3(a), the phase φ of the reflected electromagnetic wave increases from −π to π around the cavity resonant frequency. The corresponding Lorentzian delay spectrum is calculated from the first order derivatives of phase over frequency, since the frequency-dependent delay is defined as

$$τ ( ω ) = \frac{ⅆ φ ( ω )}{ⅆ ω} .$$

At resonance, light will be trapped in the cavity for some time before reflected. Two characteristic parameters of this Lorentzian delay spectrum, resonant frequency and quality factor Q, can be readily tuned with several approaches. The resonant frequency is determined by thickness of Si/SiO₂ bi-layer layer and incident angle, while Q can be adjusted with varying thickness of the defect layers, number of bi-layers on the incident side, refractive index (RI) contrast and thickness ratio. FIG. 3 shows an example of designed spectra with the resonant wavelength at 1550 nm, the FWHM of 34 GHz and its maximum delay at 18 ps.

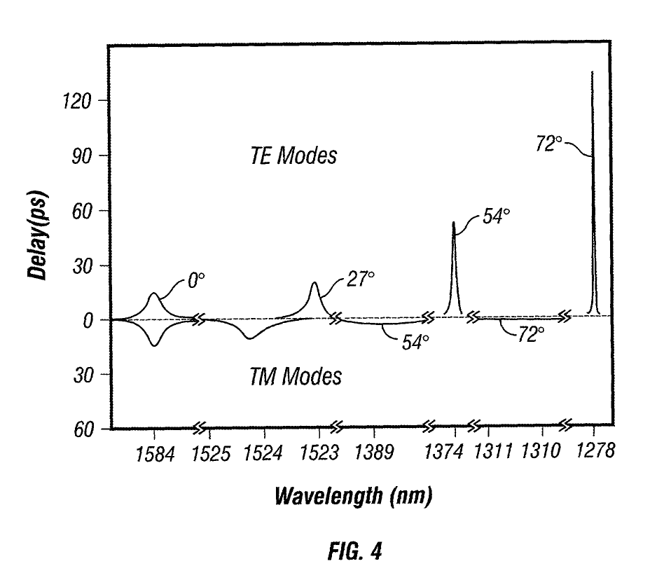

We note that contrast between the delay for the TE mode and the TM mode is quite significant at oblique incidence, as shown in FIG. 4. At the normal incidence, the group delay peaks of the two polarizations coincide with each other, as expected. As the incidence angle to the normal direction to the surface of the reflector increases from zero, these peaks shift to shorter wavelengths, while the resonant wavelength and the quality factor of the peaks for the two polarizations start to deviate from each other. The magnitude of the shift in resonant wavelengths for the TE modes is larger than that of the TM modes. Also, for the TE modes, the quality factor Q of the resonant peak and the maximum group delay increases with the incident angle, while TM modes display the opposite behavior. Therefore, this structure can be designed such that during a reflection one polarization experiences a large group delay while the other polarization has only negligible delay. This occurs, for example, at incident angles greater than about 30° to the normal direction to the surface of the reflector. This property enables usage of such micro-cavity structures in the first-order dispersion compensation.

We note that there are tremendous designing flexibilities in these structures. For practical applications, one is mostly concerned with the magnitude of the delay and the bandwidth of the delay peak. These values are directly related to the quality factor of the cavity, which is determined by the bi-layer thickness, the cavity layer thickness and the number of bi-layers on the incident side of the cavity layer. For example, a four-bi-layer (top) configuration in FIG. 1 at an incident angle of 27° has a quality factor around 6000. The quality factor reduces to 900 for the case with three top bi-layers and 150 with two top bi-layers. The quality factor of the cavity can be modified by changing the bilayer thickness ratios, since omni-directional reflection occurs for fairly wide ranges of parameters.

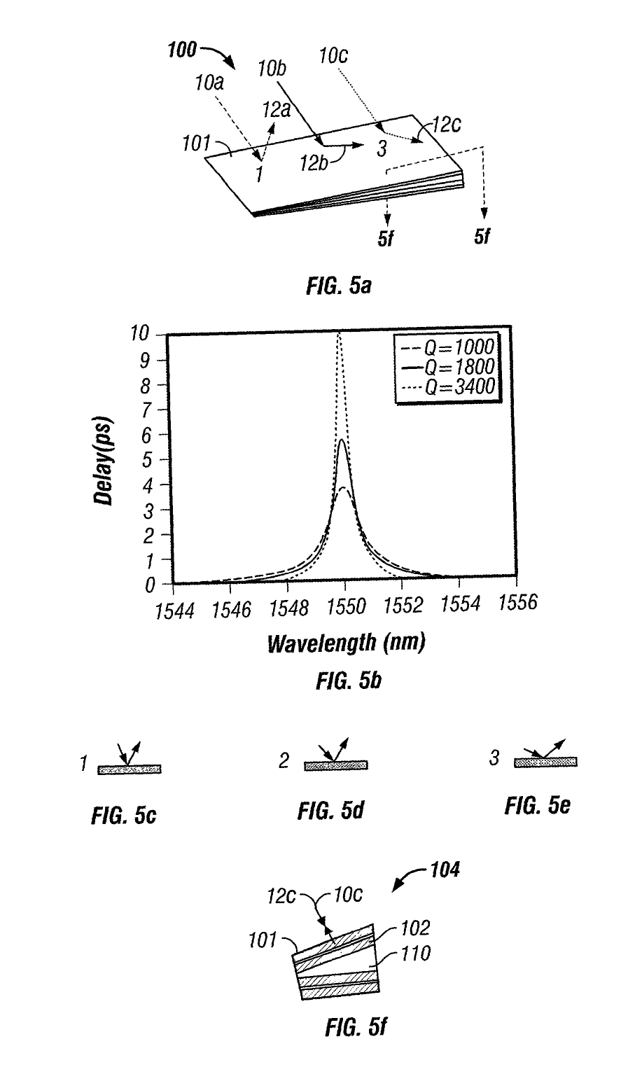

After the fabrication of a structure, its dispersion properties can be readily tuned with angular tuning which changes the resonant frequency and the quality factor of the cavity. A tapered reflector 100 of FIG. 5(a) can thus be designed so that the delay spectra show different Q while maintaining an identical resonant frequency by a combination of angular and positional tuning. Particularly, the tapered reflectors utilize the change of the bi-layer thickness to cancel the shift of the resonant frequency in the angular Q-tuning. FIG. 5(f) is a cross-sectional view of the reflector 100 of FIG. 5(a). As can been seen in FIGS. 5(a) and 5(f), a gradual thickness variation of the bi-layers is made along the direction perpendicular to the incident plane. Because the resonant wavelength is proportional to the bi-layer thickness, this variation results in a gradual change of the resonant frequency when the reflector is moved along this gradient direction. For large amplitude angular tuning, Q can be tuned for an order of magnitude, while a 22% variation of thickness across the reflector is sufficient to maintain a constant resonant frequency. As a result, adaptive tuning of quality factor is achieved with angular and translational movement of the reflector. Omni-directional reflection is preferred in this type of Q-tuning due to the large range of angles used.

Thus, as can be seen from FIG. 5(a) and more clearly from FIG. 5(f), reflector 100 has a layer 102 whose thickness varies with location along the tapering direction 104. Lines 10a. 10b, 10c indicate three different positions of beam 10 incident on surface 101 of reflector 100 at three different angles of incidence. Following the convention of FIGS. 1(a), 1(b), unshaded areas in reflector 100 indicate SiO₂, and shaded areas in reflector 100 indicate Si. A layer of silicon is removed to form cavity 110. The layers that affect the differential phase response between two orthogonal polarized components of beam 10 during the reflection are those between the cavity 110 and the surface 101. Therefore, if there is at least one layer, such as layer 102, between the cavity and the surface 101, whose thickness varies with location across surface 101, reflector 100 can be used to alter the differential phase response between two orthogonal polarized components of beam 10. Obviously more than one layer can be employed whose thickness varies with location across surface 101. Non-taper shaped reflectors with at least one layer whose thickness varies with location across surface 101 can also be used for the same purpose; such and other variations are within the scope of the invention. The thickness of such reflectors would vary in a direction normal to surface 101.

The design of the cavity also offers flexibilities in tuning. Tunability can be provided by varying physical geometric parameters, such as the thickness of cavity layer, through many micro-machining approaches including thermal (temperature tuning) or piezo-electrical actuation. These approaches are especially useful for the coupled multi-cavity reflectors, where the coupled cavity modes are very sensitive to the geometry parameters. Thus, the reflector can be tuned by applying an electric field or heat to the reflector.

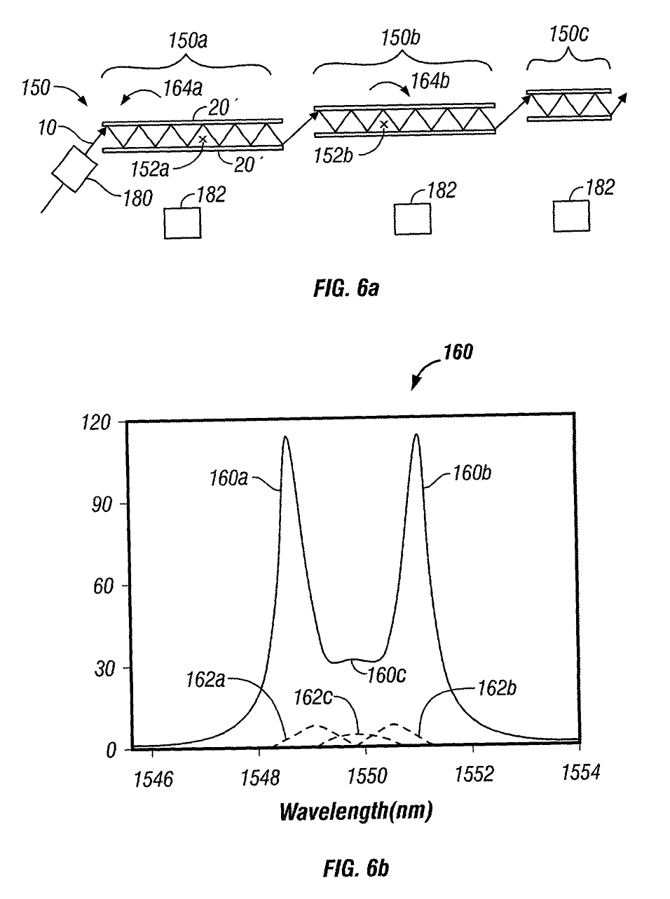

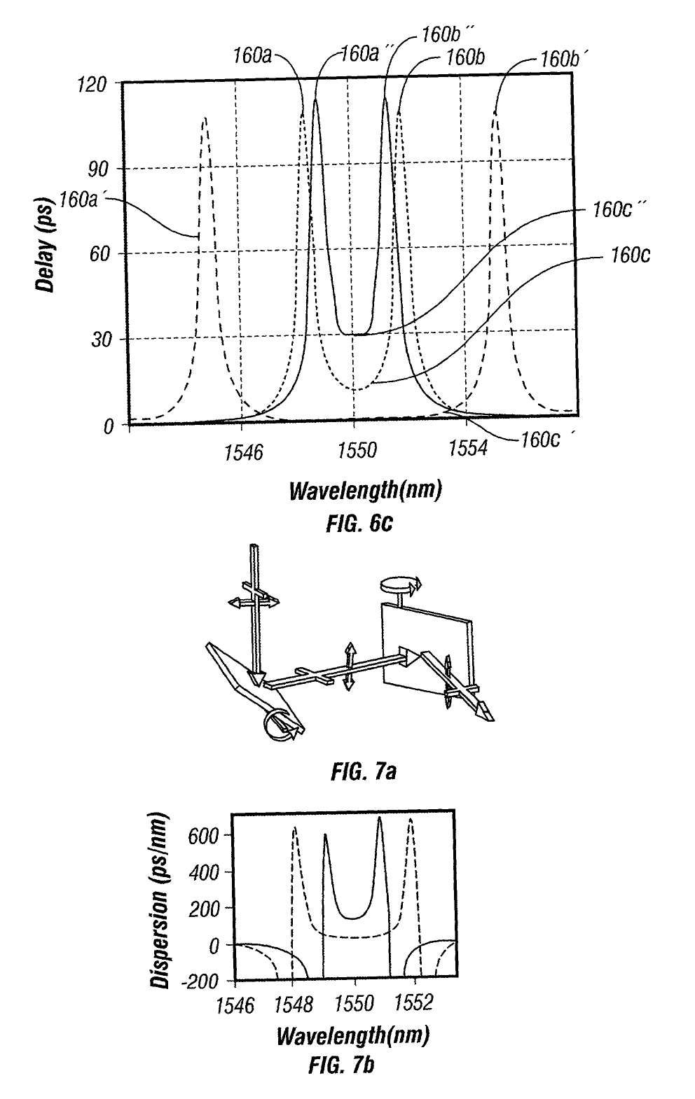

The differential delay as described above, in principle, can be used to compensate the delay between two principal states of polarization of incident wave. In order to obtain a flat delay spectrum free of the higher-order PMD, we utilize an incoherent cascading scheme with multiple stages, as shown in FIG. 6a. A device 150 comprising multiple stages 150a, 150b, 150c, each with two parallel single-cavity reflectors such as 20′ arranged at a sufficient distance apart to allow multiple reflections in each stage, allow a 0˜30 ps differential group delay continuously tunable over an 80 GHz signal band centered at the wavelength of 1550 nm. For adaptive tuning, the peaks of the two main stages 150a, 150b can be conveniently shifted by rotating the corresponding stage along the axes (such as axes 152a, 152b normal to the plane of the paper) normal to the shared incident plane (plane of the paper) which contains the beam 10 and its reflections propagating through device 150. Reducing or increasing the peak spacing thus leads to an increase or reduction of the differential group delay as illustrated in FIGS. 6(b) and 6(c). The even number of reflections at each stage ensures that the output light remains parallel to the input light, facilitating the alignment between stages even when the stages are rotated relative to one another. A supplementary third stage with only four reflections is used when large group delay is needed to further flatten the spectra when the two peaks are close to each other, as shown in FIG. 6. Tapered reflectors can also be used in the supplementary stage to flatten delay spectra in the small delay cases.

FIG. 6b is a graphical illustration of the delay spectrum of the device of FIG. 6a, where the solid line 160 corresponds to the delay spectrum of the entire device and dotted lines are those of single reflections in each stage. FIG. 6c is a graphical illustration of the delay spectrum of the structure in FIG. 6a, in the variation of the overall delay when the incidence angle is varied. The incident angle is adjusted to vary the spacing between the peaks at either side of the signal band.

In FIG. 6b, dotted line 162a corresponds to the delay spectrum of each of the single reflections in stage 150a. Dotted line 162b corresponds to the delay spectrum of each of the single reflections in stage 150b, and dotted line 162c corresponds to the delay spectrum of each of the single reflections in stage 150c. Stages 150a and 150b are rotated in opposite directions 164a, 164b about one or more axes (e.g. 152a, 152b respectively) by a small angle, such as by about 1 to 2 degrees. The rotation of stage 150a has the effect of increasing the angle of incidence of beam 10 to it, thereby causing peak 160a to shift to position 160a′ in the shorter wavelength region to the left in FIG. 6(c). The rotation of stage 150b has the effect of decreasing the angle of incidence of beam 10 to it, thereby causing peak 160a to shift to position 160b′ in the longer wavelength region to the right in FIG. 6(c). This will have the effect of reducing the delay spectrum between the peaks 160a, 160b to 160c′ which is at almost zero at 1550 nm. Rotating the stages 150a, 150b in directions opposite to 164a, 164b will have the opposite effect, thereby causing the peaks to shift to positions 160a″ and 160b″ respectively, and the delay spectrum between the peaks is increased from 160c to 160c″.

From the relative shapes of the delay spectrum in dotted lines in FIG. 6(b), it can be seen that the effect of stage 150c is to flatten the delay spectrum 160c of the device 150 between the peaks. Preferably a tapered reflector, such as that of FIGS. 5(a)-5(f), is used for the third stage 150(c). Since the resonance frequency of a multilayered structure increases with the thickness(es) of one or more layers in the structure, by moving the beam 10 from position 10a to 10b and to 10c if necessary, it is possible to increase its resonance frequency. This allows another degree of freedom to control the resonance frequency. Thus, if the angle of incidence of beam 10 to stage 150c is increased so as to increase the differential group delay so as to flatten the delay spectrum between the two peaks, this will have the unintended effect of also reducing the resonance frequency, so that it is not longer at the desired value of 1550 nm. By moving the location on surface 101 where the beam is incident on the surface, it is possible to reduce the resonance frequency until it is again at 1550 nm. We note that non-tapered reflectors with low Q may also be used as the supplemental stage. When it is desired to turn this non-tapered supplemental stage off, it can be effectively dropped by rotating it to a large incidence angle.

While a tapered reflector can be advantageously used as a supplemental stage as described above, it can be used by itself for reducing PMD. This can be done by controlling an angle of incidence between the beam and a surface of the reflector, or by causing relative motion between the beam and the surface of the reflector, so that the beam is incident on the surface at locations with the appropriate layer thickness(es), or by doing both.

The flexibility of the angular tuning schemes described above further enables generation of the tunable second-order PMD. A similar three-stage system is used as in the first-order case, except that the two first stages are now aligned in such a way that each is parallel to one of the two orthogonal polarizations, as shown in FIG. 7a. In this way, the overall differential group delay response becomes the difference between the two resonant peaks and is linear as a function of frequency between the peaks. As a result, a constant differential group velocity dispersion occurs at the signal band between the two resonant peaks. Similar to the first-order PMD compensation scheme, adjusting the spacing between the two resonant peaks by angular tuning result in tuning of the magnitude of the differential group velocity dispersion at the signal band, as illustrated in FIG. 7b, where the negative peaks are not shown. The third low-Q supplementary stage can further flatten the spectra in the case of large differential group velocity dispersion as well. In other words, all of the above-described features for first order PMD correction are applicable for differential group velocity dispersion reduction, where the orientation of the reflectors is the only difference that distinguish the second order case it from the first-order case, and similar control schemes apply to this tunable second-order PMD generation. Obviously, all of the above-described features for first order PMD correction can be used for both differential group delay reduction and differential group velocity dispersion reduction simultaneously.

Our numerical simulations indicate that a differential group velocity dispersion that is flat over a bandwidth of 100 GHz can be continuously tuned from 0 to 50 ps/nm, as illustrated in FIG. 6. For larger bandwidth, the maximum dispersion of the single reflection has to be reduced and more reflections are therefore needed in each stage.

Beam 10 preferably has two orthogonal linearly polarized components, so that interaction of the beam with a reflector with different phase response functions with respect to two orthogonal polarization directions will reduce PMD. Thus, if the polarization state of an input beam is other than linearly polarized, it is first passed through a polarization controller 180 of FIG. 6(a), before it is applied to device 150. Rotation of the stages may be performed by motors 182, where the connections between the motors and the stages are omitted to simplify the figures.

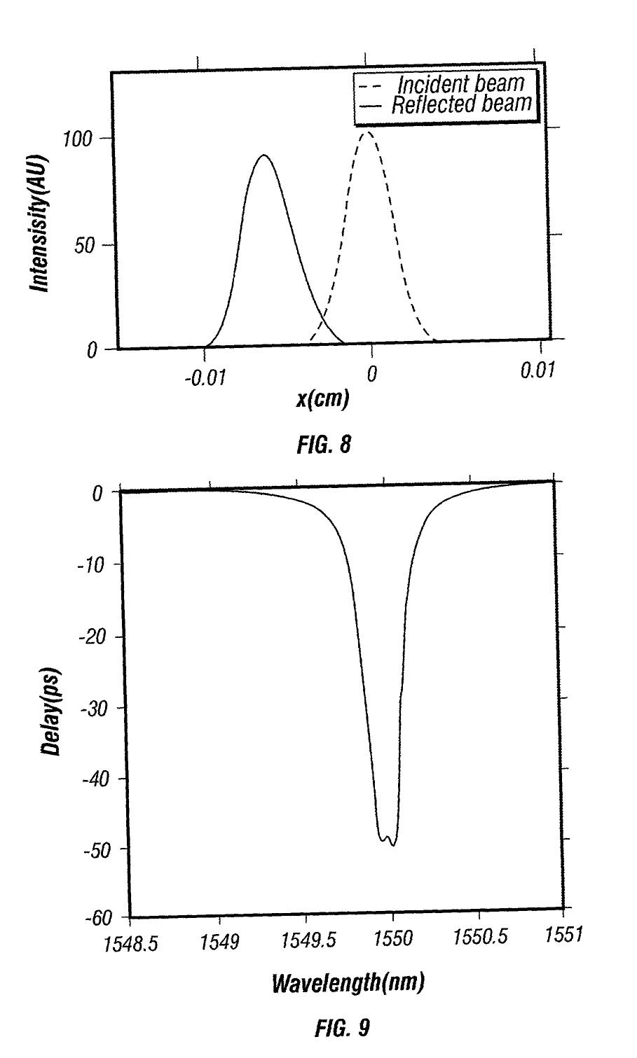

For any technique involving thin film structures at oblique incidence, the spatial distortion of the output beams has to be carefully considered to avoid coupling loss. Here, in both first and second order cases, we specifically position the signal band in a fairly flat spectral range away from the resonant frequency. Because the variation of phase occurs relatively slowly over the signal band, the spatial distortion of beams is greatly reduced. This is in contrast with a naive way to generate delay by placing the signal band at the resonance, which would incur severe spatial distortion for narrow beams as the phases vary significantly in the vicinity of the resonance. Simulations, as shown in FIG. 8, indicate that no significant distortion occurs if a beam diameter of greater than 3.5 mm is used, for the structure generating 0˜30 ps tunable deferential group delay mentioned earlier. The split between the two polarizations can be restored readily with a polarization beam splitter afterwards.

We note that the multi-cavity resonator shown in FIG. 1(b) could also be exploited to create flat delay and dispersion spectra by using cavities whose resonant frequencies differ slightly, as shown in FIG. 9. Cascaded reflections should also be adopted to further enlarge the bandwidth and to boost maximum delay. Similarly, this type of structure benefits marginal insertion loss from its total reflection nature.

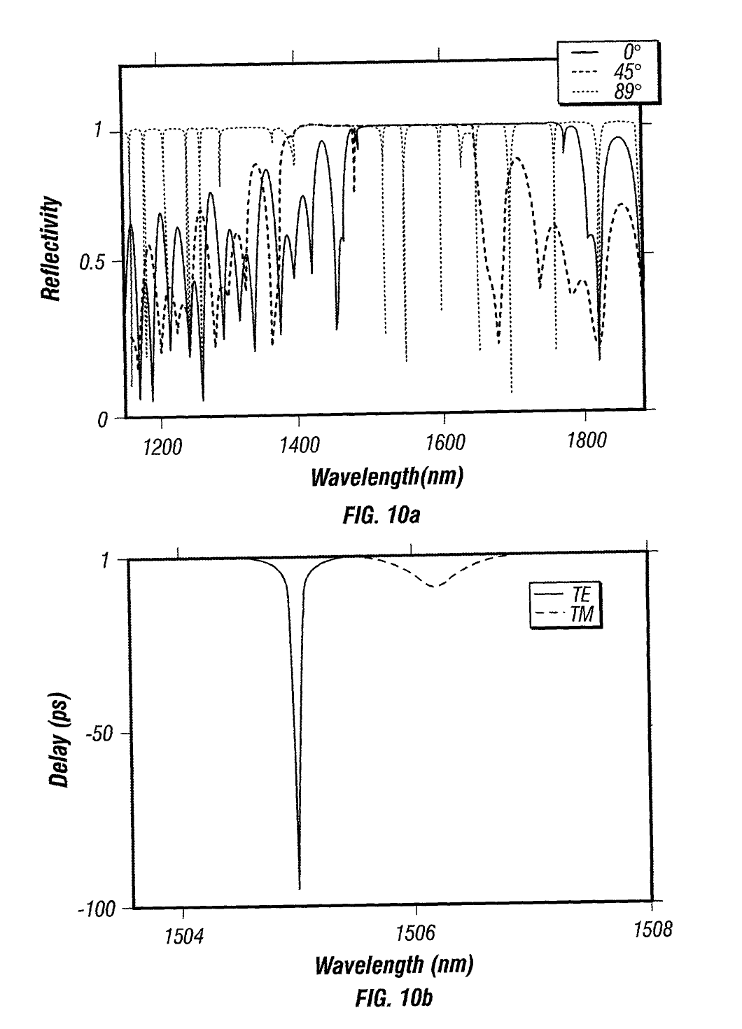

In general, total reflection of the micro-cavity reflectors is only required in the operational angular range. And thus an omni-directional reflector may not be required. For example, since the main stages of the first-order PMD generator scheme operate around a narrow angle range of 30±0.9, 100% reflectivity is only critical within this range. Consequently, it is also feasible to construct our system on reflectors built on bilayers with less refractive index contrast, which provide total reflection only in the operational incident angle range. The choices of the materials for the bi-layer are thus extended. The trade-off lies in that more number of bi-layer has to deposit to maintain the same reflectivity and quality factor above and below the micro-cavity. To replace a bi-layer composition of refractive index contrast of 3.5/1.45 (Si/SiO₂) by one with 2.2/1.7 RI contrast, without changing the quality factor, the number of the bi-layers on the top has to be doubled. In addition, for the same identical incident angle, the split between the TE and TM peaks of the cavity mode for the low RI contrast case is less than that for high RI contrast omni-directional reflector. Accordingly, reflectors with low RI contrast must operate at much larger incident angle to obtain enough separation between TE and TM resonant peaks. Such reflectors, although transmitting some light at very large incident angle, do show an identical lineshapes of delay and dispersion spectra of the cavity state in their total reflection operational range, as shown in FIG. 10. It should be noted, however, that omni-directionality may be preferred in tapered Q-tuning reflectors, because of the large angular tuning range needed.

Several advantages of using the omnidirectional micro-cavity reflectors include low insertion loss, fast response speed, a complete solution to both first-order and second-order PMD, broad bandwidth and wide wavelength tracking range. For example, a deferential group delay tuning from 0.5 ps to 30 ps corresponds to a rotation of the two main stages by only 1.7°. The small angle simplifies the control scheme and increases the potential response speed of the PMD compensator, which is critical for real-time adaptive applications. Also, the use of multi-reflection at each stage circumvents the usual tradeoff between bandwidth and maximum group delay or maximum group velocity dispersion in such resonator structures. The performance of single-cavity devices is limited by its total phase variation of 2π for single reflection over the frequency range around the resonance. In addition, the spatial beam distortion of resonant peak is alleviated by the double-peak design. Finally, the wide omnidirectional reflection range and the wide frequency coverage of angular tuning allow such designs to function properly over a wavelength tracking range of 200 nm.

While the invention has been described above by reference to various embodiments, it will be understood that changes and modifications may be made without departing from the scope of the invention, which is to be defined only by the appended claims and their equivalent. All references referred to herein are incorporated by reference in their entireties.

What is claimed is:

1. A method for polarization mode dispersion compensation, comprising:
providing a multilayer reflector device having at least one cavity therein, said device associated with different phase response functions with respect to two orthogonal polarization directions; and
interacting the device with a beam of electromagnetic radiation having two orthogonal polarized components with polarization mode dispersion between them in such manner that a differential phase response between the components is reduced.

2. The method of claim 1, wherein said two orthogonal polarized components have a differential group delay and/or a differential group velocity dispersion between the components, wherein the interacting is such that the device reduces the differential group delay and/or differential group velocity dispersion between the components.

3. The method of claim 2, said interacting comprising controlling an angle of incidence of the beam to the device, or a location of incidence of the beam on a surface of the device, to control an amount of reduction of the differential group delay and/or differential group velocity dispersion between the components.

4. The method of claim 3, wherein the surface of the device is oriented so that one of the two orthogonal polarized components is in TE mode, wherein controlling the angle of incidence of the beam to the surface of the device controls the amount of reduction of the differential group delay and/or differential group velocity dispersion between the components.

5. The method of claim 2, said device comprising multiple layers of different indices of refraction and a cavity, wherein at least one of said layers that is between the cavity and a surface of the device receiving the beam has a thickness that varies with location on the surface of the device, said interacting comprising altering an angle of incidence between the beam and the surface to adjust the amount of reduction of the differential group delay and/or differential group velocity dispersion between the components.

6. The method of claim 5, said interacting comprising controlling a location of incidence of the beam on the surface of the device to compensate for change in resonance frequency caused by the altering of the angle of incidence.

7. The method of claim 6, wherein the location of incidence of the beam on the surface of the device is controlled so that there is substantially no change in resonance frequency caused by the altering of the angle of incidence.

8. The method of claim 2, said device comprising multiple stages of reflectors, at least one of the reflectors comprising multiple layers of different indices of refraction and at least one cavity, said method further comprising rotating one or more of the reflectors in the multiple stages to adjust an amount of reduction of the differential group delay and/or differential group velocity dispersion between the components.

9. The method of claim 8, wherein the beam is incident on the multiple stages of reflectors in an incidence plane, and the rotating rotates one or more of the reflectors about a line or lines substantially normal to the plane of incidence.

10. The method of claim 9, wherein the rotating rotates two of the stages in opposite directions.

11. The method of claim 10, said device further comprising a supplemental reflector, said interacting comprising also passing the beam to the supplemental reflector to adjust the amount of reduction of the differential group delay between the components so as to flatten a portion of a spectrum of a differential phase response function of the two stages.

12. The method of claim 11, said supplemental reflector comprising multiple layers of different indices of refraction and a cavity, wherein at least one of said layers that is between the cavity and a surface of the device receiving the beam has a thickness that varies with location on the surface of the device, said interacting further comprising altering angle of incidence between the beam and the surface and/or controlling a location of incidence of the beam on the surface of the supplemental reflector.

13. The method of claim 12, wherein said angle of incidence is altered and/or said location of incidence is controlled so that predetermined spacing and group velocity delay between peaks of a delay spectrum of the two of the stages that are rotated are achieved.

14. The method of claim 8, further comprising aligning each of at least two of the multiple stages of reflectors with a direction corresponding to one of the components, to reduce the differential group velocity dispersion between the components.

15. The method of claim 14, said method further comprising rotating the at least two of the multiple stages of reflectors so that predetermined spacing and group velocity dispersion between peaks of a dispersion spectrum of the two of the stages that are rotated are achieved.

16. The method of claim 15, said device further comprising a supplemental reflector, said interacting comprising also passing the beam to the supplemental reflector to adjust the amount of reduction of the differential group velocity dispersion between the components so as to flatten a portion of a spectrum of a differential phase response function of the two stages.

17. The method of claim 16, said supplemental reflector comprising multiple layers of different indices of refraction and a cavity, wherein at least one of said layers that is between the cavity and a surface of the device receiving the beam has a thickness that varies with location on the surface of the device, said interacting further comprising altering angle of incidence between the beam and the surface and/or controlling a location of incidence of the beam on the surface of the supplemental reflector.

18. The method of claim 17, wherein said angle of incidence is altered and/or said location of incidence is controlled so that predetermined spacing and group velocity velocity dispersion between peaks of a velocity dispersion spectrum of the two of the stages that are rotated are achieved.

19. The method of claim 8, wherein said rotating adjusts the resonant frequency or frequencies of cavity or cavities in said one or more reflectors.

20. The method of claim 1, said device comprising multiple layers of different indices of refraction and a cavity, wherein at least one of said layers that is between the cavity and a surface of the device receiving the beam has a thickness that varies with location on the surface of the device, said interacting comprising controlling a location of incidence of the beam on the surface of the device to control the amount of reduction of the differential group delay and/or group velocity dispersion between the components.

21. The method of claim 1, further comprising passing radiation to a polarization controller to obtain a beam having two orthogonal linearly polarized components before interacting the beam with the device.

22. An apparatus for polarization mode dispersion compensation, comprising:
a multilayer reflector device having at least one cavity therein, said device associated with different phase response functions with respect to two orthogonal polarization directions; and
an instrument controlling an interaction between the device and a beam of electromagnetic radiation having two orthogonal polarized components with polarization mode dispersion between them in such manner that a differential phase response between the components is reduced.

23. The apparatus of claim 22, wherein said two orthogonal polarized components have a differential group delay and/or a differential group velocity dispersion between the components, wherein the instrument controls the interaction such that the device reduces the differential group delay and/or differential group velocity dispersion between the components.

24. The apparatus of claim 23, said instrument controlling an angle of incidence of the beam to the device, or a location of incidence of the beam on a surface of the device, to control an amount of reduction of the differential group delay and/or differential group velocity dispersion between the components.

25. The apparatus of claim 24, wherein the surface of the device is oriented so that one of the two orthogonal polarized components is in TE mode, wherein controlling the angle of incidence of the beam to the surface of the device controls the amount of reduction of the differential group delay and/or differential group velocity dispersion between the components.

26. The apparatus of claim 23, said device comprising multiple layers of different indices of refraction and a cavity, wherein at least one of said layers that is between the cavity and a surface of the device receiving the beam has a thickness that varies with location on the surface of the device, said instrument altering an angle of incidence between the beam and the surface to adjust the amount of reduction of the differential group delay and/or differential group velocity dispersion between the components.

27. The apparatus of claim 26, said instrument controlling a location of incidence of the beam on the surface of the device to compensate for change in resonance frequency caused by the altering of the angle of incidence.

28. The apparatus of claim 27, said instrument controlling the location of incidence of the beam on the surface of the device so that there is substantially no change in resonance frequency caused by the altering of the angle of incidence.

29. The apparatus of claim 23, said device comprising multiple stages of reflectors, at least one of the reflectors comprising multiple layers of different indices of refraction and at least one cavity, said instrument rotating one or more of the reflectors in the multiple stages to adjust an amount of reduction of the differential group delay and/or differential group velocity dispersion between the components.

30. The apparatus of claim 29, wherein the beam is incident on the multiple stages of reflectors in an incidence plane, and the said instrument controlling rotates one or more of the reflectors about a line or lines substantially normal to the plane of incidence.

31. The apparatus of claim 30, wherein the said instrument rotates two of the stages in opposite directions.

32. The apparatus of claim 31, said device further comprising a supplemental reflector adjusting the amount of reduction of the differential group delay between the components so as to flatten a portion of a spectrum of a differential phase response function of the two stages.

33. The apparatus of claim 32, said supplemental reflector comprising multiple layers of different indices of refraction and a cavity, wherein at least one of said layers that is between the cavity and a surface of the device receiving the beam has a thickness that varies with location on the surface of the device, said instrument altering an angle of incidence between the beam and the surface and/or controlling a location of incidence of the beam on the surface of the supplemental reflector.

34. The apparatus of claim 33, wherein said angle of incidence is altered and/or said location of incidence is controlled so that predetermined spacing and group velocity delay between peaks of a delay spectrum of the two of the stages that are rotated are achieved.

35. The apparatus of claim 29, wherein each of at least two of the multiple stages of reflectors is aligned with a direction corresponding to one of the components, to reduce the differential group velocity dispersion between the components.

36. The apparatus of claim 35, said instrument rotating the at least two of the multiple stages of reflectors so that predetermined spacing and group velocity dispersion between peaks of a dispersion spectrum of the two of the stages that are rotated are achieved.

37. The apparatus of claim 36, said device further comprising a supplemental reflector adjusting the amount of reduction of the differential group velocity dispersion between the components so as to flatten a portion of a spectrum of a differential phase response function of the two stages.

38. The apparatus of claim 37, said supplemental reflector comprising multiple layers of different indices of refraction and a cavity, wherein at least one of said layers that is between the cavity and a surface of the device receiving the beam has a thickness that varies with location on the surface of the device, said instrument altering an angle of incidence between the beam and the surface and/or controlling a location of incidence of the beam on the surface of the supplemental reflector.

39. The apparatus of claim 38, wherein said angle of incidence is altered and/or said location of incidence is controlled so that predetermined spacing and group velocity dispersion between peaks of a velocity dispersion spectrum of the two of the stages that are rotated are achieved.

40. The apparatus of claim 29, wherein said rotating adjusts the resonant frequency or frequencies of cavity or cavities in said one or more reflectors.

41. The apparatus of claim 29, at least one of the stages comprising two reflectors, at least one of the said reflectors comprising multiple bi-layers of different indices of refraction and at least one cavity, said two reflectors separated by a spacing so that the beam experiences multiple reflections there between.

42. The apparatus of claim 41, wherein the beam experiences even number of reflections between the two the reflectors.

43. The apparatus of claim 22, said device comprising multiple layers of different indices of refraction and a cavity, wherein at least one of said layers that is between the cavity and a surface of the device receiving the beam has a thickness that varies with location on the surface of the device, said instrument controlling a location of incidence of the beam on the surface of the device to control the amount of reduction of the differential group delay and/or group velocity dispersion between the components.

44. The apparatus of claim 22, further comprising a polarization controller operating on radiation to provide a beam having two orthogonal linearly polarized components before the beam interacts with the device.

45. The apparatus of claim 22, wherein said device comprises one or more reflector(s) that substantially completely reflects the two components over a range of incidence angles.

46. A device for polarization mode dispersion compensation, comprising multiple stages of reflectors, at least one of the stages comprising two reflectors each comprising multiple bi-layers of different indices of refraction and at least one cavity, said two reflectors separated by a spacing so that the a beam of electromagnetic radiation having two orthogonal polarized components with a polarization mode dispersion between them experiences multiple reflections there between in such manner that a differential phase response between the components is reduced.

47. The device of claim 46, wherein said two orthogonal polarized components have a differential group delay and/or a differential group velocity dispersion between the components, wherein the multiple stages of reflectors reduce the differential group delay and/or differential group velocity dispersion between the components.

48. The device of claim 46, each of the two reflectors comprising multiple bilayers of different indices of refraction and at least one cavity, said two reflectors separated by a spacing so that the beam experiences multiple reflections there between.

49. The device of claim 48, wherein the beam experiences even number of reflections between the two reflectors.

50. The device of claim 46, further comprising a polarization controller operating on radiation to provide a beam having two orthogonal linearly polarized components before the beam interacts with the stages.
